(19) United States
(12) Patent Application Publication
(10) Pub. No.: US 2015/0339127 A1
(43) Pub. Date: Nov. 26, 2015

(54) Configuration Change Tracking for Measurement Devices

(71) Applicant: National Instruments Corporation, Austin, TX (US)

(72) Inventors: Reid K. H. Lee, Cedar Park, TX (US); Matthew D. Kisler, Saint Charles, MO (US)

(73) Assignee: National Instruments Corporation, Austin, TX (US)

(21) Appl. No.: 14/286,149

(22) Filed: May 23, 2014

(51) Int. Cl. G06F 9/44

(52) U.S. Cl. CPC G06F 9/4401

(57) ABSTRACT

System and method for configuring a measurement device. An initial configuration of a measurement device may be stored on a storage medium. In response to a change in the configuration of the measurement device, information indicating the change in the configuration may be stored on the storage medium, where the change in the configuration results in a modified configuration. Storing the information indicating the change in the configuration may be repeated one or more times for respective changes. The stored initial configuration and the stored information indicating changes in the configuration may comprise a history of configuration changes for the measurement device which may be useable to perform one or more of: generating a report regarding the measurement device, displaying a history of changes in the configuration of the measurement device, or reverting the measurement device to a previous configuration.

### FIELD OF THE INVENTION

The present invention relates to the field of measurement, and more particularly to a system and method of configuration tracking for measurement devices, e.g., for configuration reversion or differencing.

### DESCRIPTION OF THE RELATED ART

When a measurement device, such as a benchtop (e.g., boxed or standalone) or PXI (PCI (Peripheral Component Interconnect) eXtensions for Instrumentation) instrument, is used with or in an automation system or application, e.g., via a programming/sequencing environment, the measurement device's configuration state (or simply “configuration”) may be altered by using the device's physical front panel or through a software application (that provides a “soft front panel”) in order to debug the automated test or device under test. Once debugging is complete, the user currently does not have a way to “revert” the changes to configuration made through the device's front panel or software application. In addition, the user may not know of all the configuration changes that occurred (were made) while debugging.

Graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, modeling, simulation, image processing/machine vision applications, and motion control, among others.

### SUMMARY OF THE INVENTION

Various embodiments of a system and method for configuration change tracking for measurement devices are presented below.

In one embodiment, an initial configuration of a measurement device may be stored on a storage medium. The measurement device may be or include a standalone instrument, a module in a chassis, a chassis with a plurality of modules, and/or a device that includes a software component, executable on a host computer, and a hardware component, coupled to the host computer, among others.

In response to a change in the configuration of the measurement device resulting in a modified configuration, information indicating the modified configuration may be stored on the storage medium. This storing of information indicating the modified configuration may be repeated one or more times. The stored initial configuration and the stored information indicating each modified configuration may include or form a history of configuration changes for the measurement device, where the history of configuration changes is useable to generate a report regarding the measurement device, display the history of configuration changes for the measurement device, or revert the measurement device to a previous configuration, among other uses.

The stored information indicating each modified configuration may take any of a variety of form. For example, the stored information may include new values for one or more configuration parameters of the measurement device resulting from each change in configuration, where the new values for the one or more configuration parameters override previous values of the one or more configuration parameters. In another embodiment, the stored information indicating each modified configuration may include values of configuration parameters that have not been changed from the initial configuration, and new values for configuration parameters of the measurement device resulting from the changes in configuration, wherein later new values override previous new values. In a further embodiment, the stored information indicating changes in the configuration may include respective differences between the modified configurations of the measurement device resulting from the changes in configuration and the initial configuration.

In some embodiments, the method may also include determining respective differences between the initial configuration and each modified configuration based on the history of configuration changes for the measurement device.

The initial configuration and the modified configurations may be or include a plurality of configurations, and in some embodiments, user input may be received indicating a first configuration of the plurality of configurations, and the first configuration may be selected in response to said receiving user input, where the first configuration is useable to configure the measurement device. Additionally, in one embodiment, a program may be automatically generated that is executable to configure the measurement device in accordance with the selected configuration. For example, configuring the measurement device in accordance with the selected configuration may include modifying the initial configuration of the measurement device in accordance with the selected configuration, or replacing the initial configuration of the measurement device with the selected configuration. The generated program may be of any type desired. For example, in one embodiment, the program may be or include a graphical program, e.g., a graphical data flow program.

In one embodiment, the method may perform or implement undo or redo functionality in response to user input based on the history of configuration changes, where at least one of the changes in configuration results from an undo or redo operation.

### BRIEF DESCRIPTION OF THE DRAWINGS

A better understanding of the present invention can be obtained when the following detailed description of the preferred embodiment is considered in conjunction with the following drawings, in which:

FIG. 1A illustrates an exemplary system configured to implement embodiments of the present invention;

FIG. 1B illustrates an exemplary standalone measurement device configured to implement embodiments of the present invention;

FIG. 2A illustrates an instrumentation control system according to one embodiment of the invention;

FIG. 2B illustrates an industrial automation system according to one embodiment of the invention;

FIG. 3A is a high level block diagram of an exemplary system which may execute or utilize graphical programs;

FIG. 3B illustrates an exemplary system which may perform control and/or simulation functions utilizing graphical programs;

FIG. 4 is an exemplary block diagram of the computer systems of FIGS. 1A, 2A, 2B, and 3B;

FIG. 5 is a flowchart diagram illustrating one embodiment of a method for configuration change tracking for a measurement device;

FIG. 6 is a screenshot illustrating an exemplary graphical user interface (GUI), according to one embodiment;

FIG. 7 illustrates an exemplary generated graphical program executable to implement the changes in configuration shown in FIG. 6, according to one embodiment; and

FIG. 8 illustrates an exemplary high level system architecture, according to one embodiment.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

Incorporation by Reference:

The following references are hereby incorporated by reference in their entirety as though fully and completely set forth herein:

U.S. application Ser. No. 13/433,471 titled “Annotating Measurement Results Data Capture Images with Instrumentation Configuration”, filed Mar. 29, 2012.

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. Pat. No. 7,210,117 titled “System and Method for Programmatically Generating a Graphical Program in Response to Program Information,” filed Dec. 20, 2000.

### Terms

The following is a glossary of terms used in the present application:

Memory Medium—Any of various types of non-transitory computer accessible memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, PASCAL, FORTRAN, COBOL, JAVA, assembly language, etc.; graphical programs (programs written in graphical programming languages); assembly language programs; programs that have been compiled to machine language; scripts; and other types of executable software. A software program may comprise two or more software programs that interoperate in some manner. Note that various embodiments described herein may be implemented by a computer or software program. A software program may be stored as program instructions on a memory medium.

Hardware Configuration Program—a program, e.g., a netlist or bit file, that can be used to program or configure a programmable hardware element.

Program—the term “program” is intended to have the full breadth of its ordinary meaning. The term “program” includes 1) a software program which may be stored in a memory and is executable by a processor or 2) a hardware configuration program useable for configuring a programmable hardware element.

Graphical Program—A program comprising a plurality of interconnected nodes or icons, wherein the plurality of interconnected nodes or icons visually indicate functionality of the program. The interconnected nodes or icons are graphical source code for the program. Graphical function nodes may also be referred to as blocks.

The following provides examples of various aspects of graphical programs. The following examples and discussion are not intended to limit the above definition of graphical program, but rather provide examples of what the term “graphical program” encompasses:

The nodes in a graphical program may be connected in one or more of a data flow, control flow, and/or execution flow format. The nodes may also be connected in a “signal flow” format, which is a subset of data flow.

Exemplary graphical program development environments which may be used to create graphical programs include LabVIEW®, DasyLab™, DIADem™ and Matrixx/SystemBuild™ from National Instruments, Simulink® from the MathWorks, VEE™ from Agilent, WiT™ from Coreco, Vision Program Manager™ from PPT Vision, SoftWIRE™ from Measurement Computing, Sanscript™ from Northwoods Software, Khoros™ from Khoral Research, SnapMaster™ from HEM Data, VisSim™ from Visual Solutions, ObjectBench™ by SES (Scientific and Engineering Software), and VisiDAQ™ from Advantech, among others.

The term “graphical program” includes models or block diagrams created in graphical modeling environments, wherein the model or block diagram comprises interconnected blocks (i.e., nodes) or icons that visually indicate operation of the model or block diagram; exemplary graphical modeling environments include Simulink®, SystemBuild™, VisSim™, Hypersignal Block Diagram™, etc.

A graphical program may be represented in the memory of the computer system as data structures and/or program instructions. The graphical program, e.g., these data structures and/or program instructions, may be compiled or interpreted to produce machine language that accomplishes the desired method or process as shown in the graphical program.

Input data to a graphical program may be received from any of various sources, such as from a device, unit under test, a process being measured or controlled, another computer program, a database, or from a file. Also, a user may input data to a graphical program or virtual instrument using a graphical user interface, e.g., a front panel.

A graphical program may optionally have a GUI associated with the graphical program. In this case, the plurality of interconnected blocks or nodes are often referred to as the block diagram portion of the graphical program.

Node—In the context of a graphical program, an element that may be included in a graphical program. The graphical program nodes (or simply nodes) in a graphical program may also be referred to as blocks. A node may have an associated icon that represents the node in the graphical program, as well as underlying code and/or data that implements functionality of the node. Exemplary nodes (or blocks) include function nodes, sub-program nodes, terminal nodes, structure nodes, etc. Nodes may be connected together in a graphical program by connection icons or wires.

Data Flow Program—A Software Program in which the program architecture is that of a directed graph specifying the flow of data through the program, and thus functions execute whenever the necessary input data are available. Said another way, data flow programs execute according to a data flow model of computation under which program functions are scheduled for execution in response to their necessary input data becoming available. Data flow programs can be contrasted with procedural programs, which specify an execution flow of computations to be performed. As used herein “data flow” or “data flow programs” refer to “dynamically-scheduled data flow” and/or “statically-defined data flow”.

Graphical Data Flow Program (or Graphical Data Flow Diagram)—A Graphical Program which is also a Data Flow Program. A Graphical Data Flow Program comprises a plurality of interconnected nodes (blocks), wherein at least a subset of the connections among the nodes visually indicate that data produced by one node is used by another node. A LabVIEW VI is one example of a graphical data flow program. A Simulink block diagram is another example of a graphical data flow program.

Graphical User Interface—this term is intended to have the full breadth of its ordinary meaning The term “Graphical User Interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window having one or more GUI Elements, or may comprise a plurality of individual GUI Elements (or individual windows each having one or more GUI Elements), wherein the individual GUI Elements or windows may optionally be tiled together.

A GUI may be associated with a graphical program. In this instance, various mechanisms may be used to connect GUI Elements in the GUI with nodes in the graphical program. For example, when Input Controls and Output Indicators are created in the GUI, corresponding nodes (e.g., terminals) may be automatically created in the graphical program or block diagram. Alternatively, the user can place terminal nodes in the block diagram which may cause the display of corresponding GUI Elements front panel objects in the GUI, either at edit time or later at run time. As another example, the GUI may comprise GUI Elements embedded in the block diagram portion of the graphical program.

Front Panel—A Graphical User Interface that includes input controls and output indicators, and which enables a user to interactively control or manipulate the input being provided to a program, and view output of the program, while the program is executing.

A front panel is a type of GUI. A front panel may be associated with a graphical program as described above.

In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators.

Graphical User Interface Element—an element of a graphical user interface, such as for providing input or displaying output. Exemplary graphical user interface elements comprise input controls and output indicators.

Input Control—a graphical user interface element for providing user input to a program. An input control displays the value input by the user and is capable of being manipulated at the discretion of the user. Exemplary input controls comprise dials, knobs, sliders, input text boxes, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are configured to acquire and/or store data. A measurement device may also optionally be further configured to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further configured to perform control functions, e.g., in response to analysis of the acquired or stored data. For example, the measurement device may send a control signal to an external system, such as a motion control system or to a sensor, in response to particular data. A measurement device may also be configured to perform automation functions, i.e., may receive and analyze data, and issue automation control signals in response.

Functional Unit (or Processing Element)—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors, as well as any combinations thereof

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

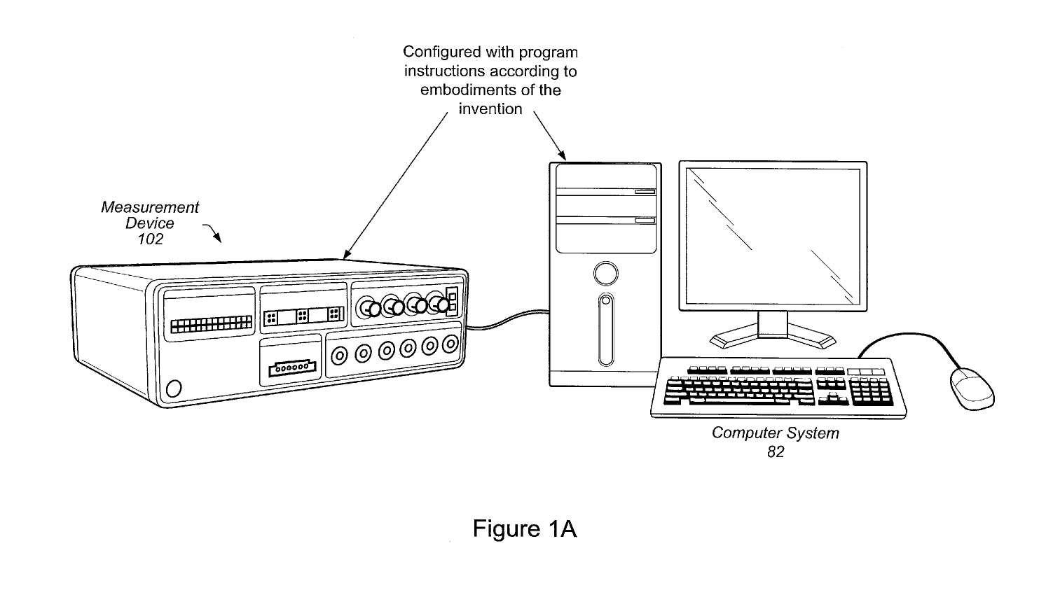

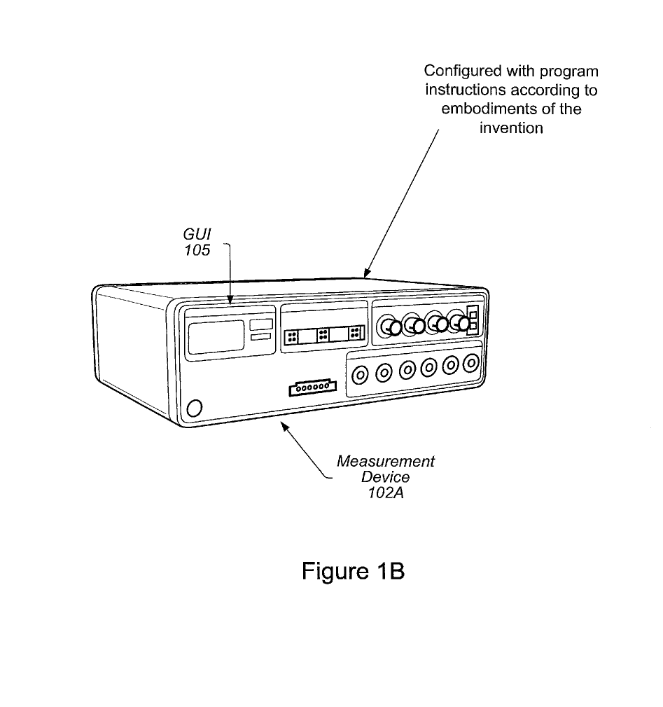

### FIG. 1A—Computer System

FIG. 1A illustrates an exemplary system configured to implement embodiments of the present invention. As may be seen, this exemplary system includes a measurement device 102 coupled to a host computer system 82. The measurement device 102 may be any type of measurement device desired. For example, in various embodiments, the measurement device may be or include one or more of: a standalone instrument, a module in a chassis, a chassis with a plurality of modules, or a device that includes a software component, executable on a host computer, such as computer system 82, and a hardware component, such as measurement device 102, coupled to the host computer. Note that, while in the embodiment shown, the measurement device is coupled to the host computer via a cable, in other embodiments, other communicative coupling means may be used, e.g., a wireless connection, a local area network (LAN), or a wide area network (WAN), such as the Internet, among others.

As shown in FIG. 1A, the computer system 82 may include a display device configured to display the graphical program as the graphical program is created and/or executed. The display device may also be configured to display a graphical user interface or front panel of the graphical program during execution of the graphical program. The graphical user interface may comprise any type of graphical user interface (GUI), e.g., depending on the computing platform. In one embodiment, the GUI may be or include a soft front panel (SFP) for the measurement device that implements a software based front panel interface for the measurement device.

The computer system 82 may include at least one memory medium on which one or more computer programs or software components according to one embodiment of the present invention may be stored. For example, the memory medium may store one or more programs, e.g., text based or graphical programs, which are executable to perform the methods described herein. As noted above, in some embodiments, the memory medium may store a software component of a measurement device that is executable to control or otherwise operate with the measurement device, e.g., a driver program and/or application program. Additionally, the memory medium may store a (possibly) graphical programming development environment application used to create and/or execute such programs. The memory medium may also store operating system software, as well as other software for operation of the computer system.

The computer system 82 may be any of various types as desired, e.g., a workstation, a personal computer, a mobile computing device, such as a tablet computer or smart phone, a controller in a chassis, and so forth. In some embodiments, the computer system 82 and measurement device 102 may execute a (possibly graphical) program in a distributed fashion. For example, computer 82 may execute a first portion of a block diagram of a graphical program and computer system 90 may execute a second portion of the block diagram of the graphical program. As another example, computer 82 may display the graphical user interface of a program and measurement device 102 may execute the functional body of the program, e.g., the block diagram of the graphical program.

Various embodiments further include receiving or storing instructions and/or data implemented in accordance with the foregoing description upon a carrier medium.

FIG. 1B—Computer Network

FIG. 1B illustrates another exemplary system implementing embodiments of the present techniques, specifically, a measurement device 102A configured to perform embodiments of the methods disclosed herein. Accordingly, measurement device 102A may include a processor and memory medium that stores program instructions executable by the processor to implement these techniques, e.g., driver software, user application(s), etc. Note that measurement device 102A includes a graphical user interface (GUI) 105 for user interactions with the device.

It should be noted, however, that the measurement devices 102 and 102A of FIGS. 1A and 1B are exemplary only, and, as noted above, any type of measurement device may be used as desired.

### Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the present techniques may be used include hardware-in-the-loop testing and rapid control prototyping, among others.

However, it is noted that embodiments of the present invention can be used for a plethora of applications and is not limited to the above applications. In other words, applications discussed in the present description are exemplary only, and embodiments of the present invention may be used in any of various types of systems. Thus, embodiments of the system and method of the present invention is configured to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

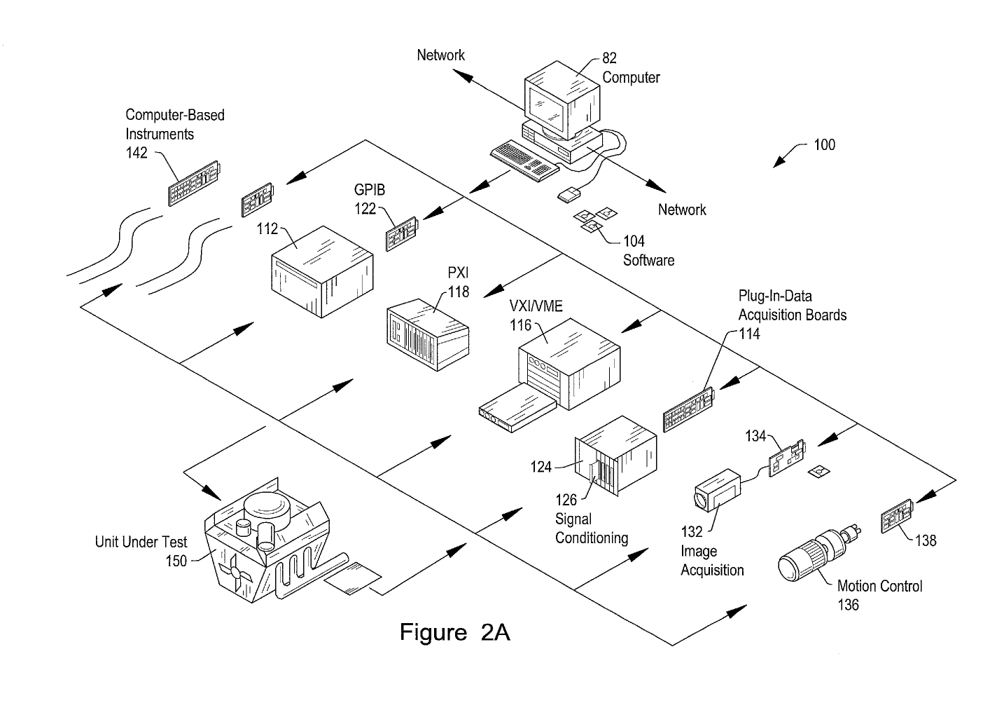

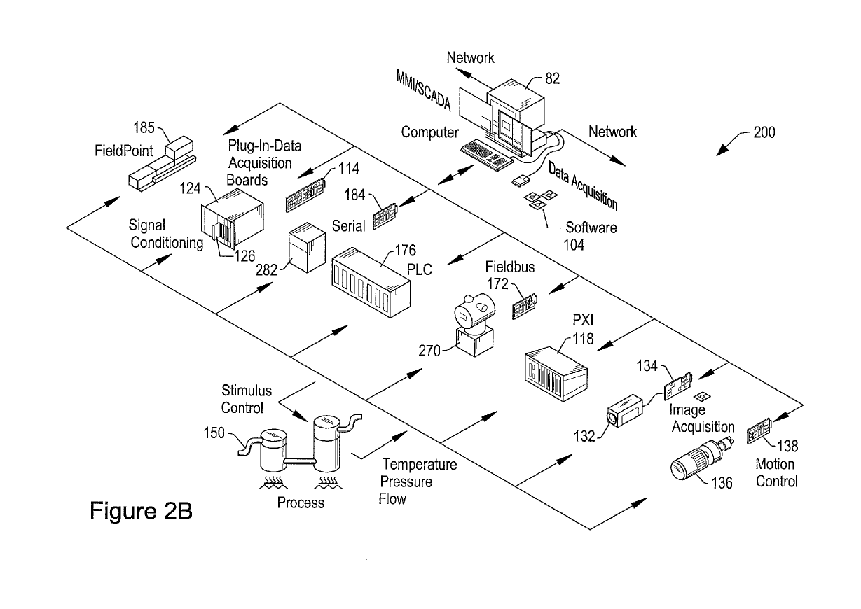

FIG. 2A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150, e.g., via execution of software 104. In various embodiments, any of the instruments may be configured (possibly with the host computer 82) to implement and perform embodiments of the techniques disclosed herein.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in any kind of measurement related application as desired, e.g., a data acquisition and control application, in a test and measurement application, an image processing or machine vision application, a process control application, a man-machine interface application, a simulation application, or a hardware-in-the-loop validation application, among others.

FIG. 2B illustrates an exemplary industrial automation system 200 which may implement embodiments of the invention. The industrial automation system 200 is similar to the instrumentation or test and measurement system 100 shown in FIG. 2A. Elements which are similar or identical to elements in FIG. 2A have the same reference numerals for convenience. The system 200 may comprise a computer 82 which couples to one or more devices or instruments. The computer 82 may comprise a CPU, a display screen, memory, and one or more input devices such as a mouse or keyboard as shown. The computer 82 may operate with the one or more devices to perform an automation function with respect to a process or device 150, such as MMI (Man Machine Interface), SCADA (Supervisory Control and Data Acquisition), portable or distributed data acquisition, process control, advanced analysis, or other control, among others, e.g., via execution of software 104.

As with the system of FIG. 2A, in various embodiments, any of the instruments may be configured (possibly with the host computer 82) to implement and perform embodiments of the techniques disclosed herein.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 270 and associated fieldbus interface card 172, a PLC (Programmable Logic Controller) 176, a serial instrument 282 and associated serial interface card 184, or a distributed data acquisition system, such as Fieldpoint system 185, available from National Instruments Corporation, among other types of devices.

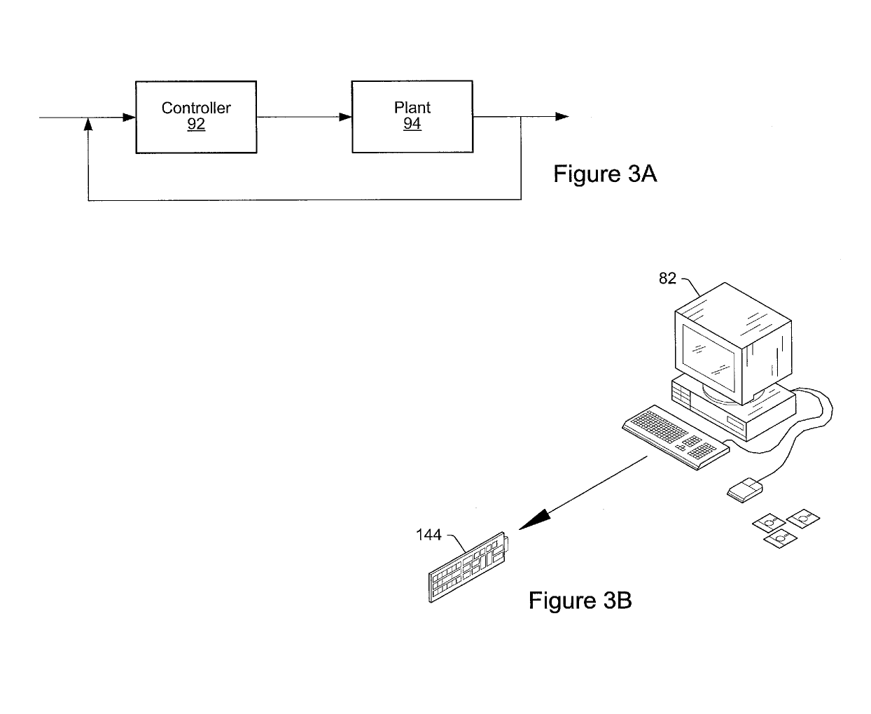

FIG. 3A is a high level block diagram of an exemplary system which may execute or utilize programs, e.g., graphical programs, according to the present techniques. FIG. 3A illustrates a general high-level block diagram of a generic control and/or simulation system which comprises a controller 92 and a plant 94. The controller 92 represents a control system/algorithm the user may be trying to develop. The plant 94 represents the system the user may be trying to control. For example, if the user is designing an ECU for a car, the controller 92 is the ECU and the plant 94 is the car's engine (and possibly other components such as transmission, brakes, and so on.) As shown, a user may create a graphical program that specifies or implements the functionality of one or both of the controller 92 and the plant 94. For example, a control engineer may use a modeling and simulation tool to create a model (graphical program) of the plant 94 and/or to create the algorithm (graphical program) for the controller 92.

FIG. 3B illustrates an exemplary system which may perform control and/or simulation functions. As shown, the controller 92 may be implemented by a computer system 82 or other device (e.g., including a processor and memory medium and/or including a programmable hardware element) that executes a program, e.g., a graphical program, to perform embodiments of the present techniques. In a similar manner, the plant 94 may be implemented by a computer system or other device 144 (e.g., including a processor and memory medium and/or including a programmable hardware element) that executes or implements a program, e.g., a graphical program, or may be implemented in or as a real physical system, e.g., a car engine.

In one embodiment of the invention, one or more graphical programs may be created which are used in performing rapid control prototyping. Rapid Control Prototyping (RCP) generally refers to the process by which a user develops a control algorithm and quickly executes that algorithm on a target controller connected to a real system. The user may develop the control algorithm using a graphical program, and the graphical program may execute on the controller 92, e.g., on a computer system or other device. The computer system 82 may be a platform that supports real time execution, e.g., a device including a processor that executes a real time operating system (RTOS), or a device including a programmable hardware element.

In one embodiment of the invention, one or more graphical programs may be created which are used in performing Hardware in the Loop (HIL) simulation. Hardware in the Loop (HIL) refers to the execution of the plant model 94 in real time to test operation of a real controller 92. For example, once the controller 92 has been designed, it may be expensive and complicated to actually test the controller 92 thoroughly in a real plant, e.g., a real car. Thus, the plant model (implemented by a graphical program) is executed in real time to make the real controller 92 “believe” or operate as if it is connected to a real plant, e.g., a real engine.

In the embodiments of FIGS. 2A, 2B, and 3B above, one or more of the various devices may couple to each other over a network, such as the Internet. In one embodiment, the user operates to select a target device from a plurality of possible target devices for programming or configuration using a graphical program. Thus the user may create a graphical program on a computer and use (execute) the graphical program on that computer or deploy the graphical program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 2A and 2B, may be referred to as virtual instruments.

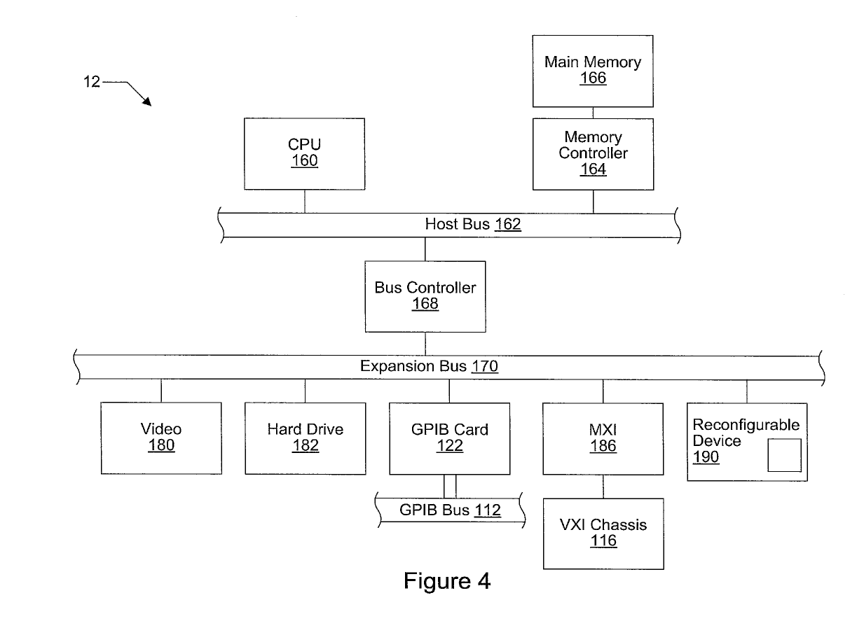

### FIG. 4—Computer System Block Diagram

FIG. 4 is a block diagram 12 representing one embodiment of the computer system 82 illustrated in FIG. 1A, or computer system 82 shown in FIGS. 2A or 2B. It is noted that any type of computer system configuration or architecture can be used as desired, and FIG. 4 illustrates a representative PC embodiment. It is also noted that the computer system may be a general purpose computer system, a computer implemented on a card installed in a chassis, or other types of embodiments. Elements of a computer not necessary to understand the present description have been omitted for simplicity.

The computer may include at least one central processing unit or CPU (processor) 160 which is coupled to a processor or host bus 162. The CPU 160 may be any of various types, including an x86 processor, e.g., a Pentium class, a PowerPC processor, a CPU from the SPARC family of RISC processors, as well as others. A memory medium, typically comprising RAM and referred to as main memory, 166 is coupled to the host bus 162 by means of memory controller 164. The main memory 166 may store one or more programs configured to implement embodiments of the present invention, e.g., the configuration change tracking functionality described herein. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as described above. The computer 82 further comprises a video display subsystem 180 and hard drive 182 coupled to the expansion bus 170. The computer 82 may also comprise a GPIB card 122 coupled to a GPIB bus 112, and/or an MXI device 186 coupled to a VXI chassis 116. More generally, as noted above, the computer 82 may be coupled to any of various measurement devices.

As shown, a device 190 may also be connected to the computer. The device 190 may include a processor and memory which may execute a real time operating system. The device 190 may also or instead comprise a programmable hardware element. The computer system may be configured to deploy a graphical program to the device 190 for execution of the graphical program on the device 190. The deployed graphical program may take the form of graphical program instructions or data structures that directly represents the graphical program. Alternatively, the deployed graphical program may take the form of text code (e.g., C code) generated from the graphical program. As another example, the deployed graphical program may take the form of compiled code generated from either the graphical program or from text code that in turn was generated from the graphical program.

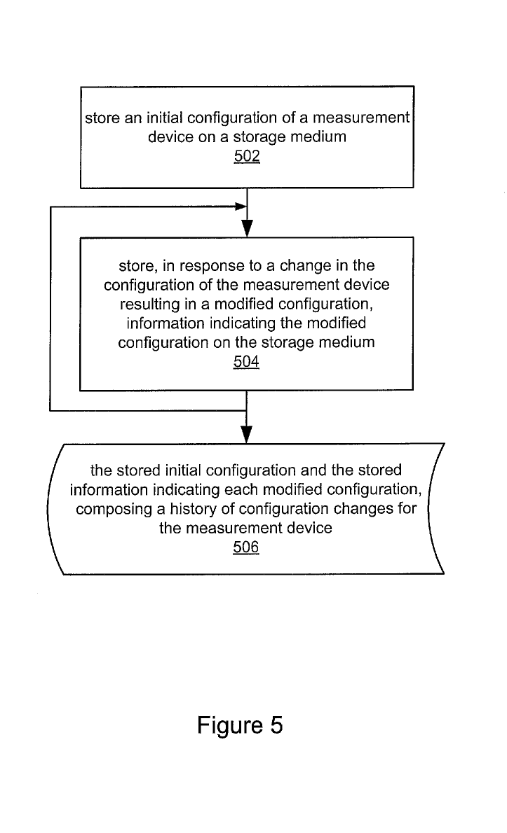

### FIG. 5—Flowchart of a Method for Configuration Change Tracking

FIG. 5 is a flowchart illustrating a method for configuration change tracking for a measurement device, according to one embodiment. The method shown in FIG. 5 may be performed by or used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

First, in 502, an initial configuration (i.e., initial configuration information) of a measurement device may be stored on a storage medium, e.g., a memory medium. Said another way, a measurement device's current configuration may be stored in a storage medium. The configuration may comprise configuration data in any form or format desired. For example, the initial configuration may be in the form of one or more configuration files, e.g., text files, containing values of configuration parameters for the measurement device. As noted above, the measurement device may any type of measurement device desired, including, but not limited to, one or more of: a standalone instrument, a module in a chassis, a chassis with a plurality of modules, or a device comprising: a software component, executable on a host computer, and a hardware component, coupled to the host computer. In one embodiment, the hardware component may be a computer card or board installed in the host computer.

In 504, in response to a change in the configuration of the measurement device resulting in a modified configuration, information indicating the modified configuration may be stored on the storage medium. Moreover, as indicated in FIG. 5, method element 504 may be repeated one or more times, resulting in the storage or disposition of the information (indicating each of the respective modified configurations) on the storage medium, as indicated in 506. The stored initial configuration and the stored information indicating each modified configuration may be or include a history of configuration changes for the measurement device. For example, the information may also indicate the order of the changes and resulting modified configurations. The history of configuration changes may be useable for various purposes, including, but not limited to, one or more of: generating a report regarding the measurement device, displaying the history of configuration changes for the measurement device, or reverting the measurement device to a previous configuration, among others.

Note that the information may indicate each modified configuration in any of a variety of manners. For example, in some embodiments, the information may include new values for one or more configuration parameters of the measurement device resulting from each change in configuration, where the new values for the one or more configuration parameters override previous values of the one or more configuration parameters. In other words, for a given change in configuration, the information may include new (i.e., changed) values for one or more parameters that preempt any previous values for those parameters.

In some such embodiments, the information indicating each modified configuration may include not only values for the one or more configuration parameters that were modified for that change in configuration, but values for all configuration parameters for the measurement device after the change in configuration. In other words, the information indicating a specific modified configuration may be or specify the complete or full (modified) configuration. Said another way, the stored information indicating each modified configuration may include values of configuration parameters that have not been changed from the initial configuration, and new values for configuration parameters of the measurement device resulting from the changes in configuration, wherein later new values override previous new values.

In one such embodiment, parameters that have been changed from the initial configuration may be indicated, e.g., tagged, and so differences (i.e., the “delta”) between the initial configuration and the specific modified configuration may be determined solely from the information indicating the specific modified configuration.

In another embodiment, the parameters that have been changed from the initial configuration may not be indicated/tagged, and the differences between the initial configuration and the specific modified configuration may be determined by “diffing” the modified configuration with the initial configuration.

Alternatively, in some embodiments, the information indicating a particular modified configuration may include values for the one or more configuration parameters that were modified for that change in configuration, i.e., the information may not include values for parameters that were not modified in this particular change in configuration. In other words, the stored information indicating changes in the configuration may include respective differences between the modified configurations of the measurement device resulting from the changes in configuration and the initial configuration.

Note, however, that per these embodiments, to ascertain or otherwise determine the complete (particular) modified configuration for the measurement device, it may be necessary to recapitulate all of the modifications to parameters leading up to the modified configuration. Said another way, to determine the full particular modified configuration, it may be necessary to take the initial configuration, and, based on the respective information indicating each modified configuration, apply each respective change in configuration to the initial configuration in the order in which the respective changes were made. This recapitulation may thus produce the collective result of all changes leading up to the particular modified configuration.

In further embodiments, the information indicating a particular modified configuration may include only values for the one or more configuration parameters that have been modified up to that point, i.e., the information may not include values for parameters that were not modified from the initial configuration. Thus, values from the initial configuration may be required to determine the complete (particular) modified configuration.

In yet further embodiments, the information indicating a particular modified configuration may include net changes in values for the one or more configuration parameters that have been modified up to that point, i.e., any “delta” or “diff” in parameter values with respect to the initial configuration. Thus, to produce the complete (particular) modified configuration, the “delta” for each modified parameter value may simply be added to the value in the initial configuration.

Alternatively, the information indicating a particular modified configuration may include relative or incremental changes in values for the one or more configuration parameters with respect to the previous modified configuration, e.g., the information indicating each modified configuration may be or include “relative deltas” or “relative diffs” with respect to the immediately previous configuration. In other words, each “delta” may be with respect to the previous (e.g., modified) configuration, e.g., “plus 0.3”, and so generating the complete particular modified configuration may include accumulating all such deltas, beginning with the initial configuration and accumulating all the relative deltas in order.

In some embodiments, the method may further include determining respective differences between the initial configuration and each modified configuration based on the history of configuration changes for the measurement device. These differences may be displayed to the user, used to generate a report or produce a specific (modified) configuration, or analyzed, e.g., to determine relationships between different parameters, e.g., complex non-linear dependencies.

Note, however, that any other information indicating the modified configurations may be used as desired, with associated techniques for determining or producing the modified configuration. For example, any combination of the above approaches may be used as desired. As one particular example, the information indicating a particular modified configuration may include old value/new value pairs for each changed parameter, from which a “delta” or “diff” for each parameter may be determined, and/or from which the associated or resultant modified configuration may be determined.

The initial configuration and the modified configurations form a plurality of configurations. In some embodiments, the method may include receiving user input indicating a first configuration of the plurality of configurations, and selecting the first configuration in response (to the receiving user input), where the first configuration is useable to configure the measurement device. In other words, each of the initial and modified configurations may be selectable by the user (or some subsequent user), and used to configure the measurement device. Such selection by the user may be made in any of a variety of ways, including, for example, selecting from a display of the history of configuration changes, which itself may be of any of a variety of forms, as indicated above.

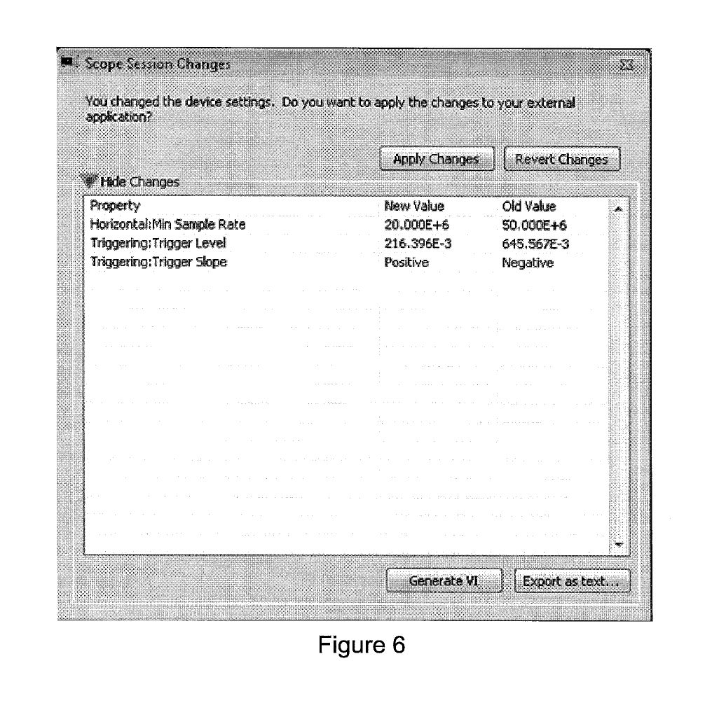

FIG. 6 is a screenshot of an exemplary graphical user interface (GUI) illustrating one exemplary use case, where a user runs a (e.g., his or her) custom application that configures the measurement device (i.e., the measurement device's state), e.g., on a host computer, and issues commands to read data from the measurement device. At some point, the user determines that the measurement device is not configured correctly (e.g., the measurement device's trigger level may be set incorrectly). Because the user may not have access to the application source code, or because it is cumbersome to rebuild the application every time the user wants to try a new configuration, a GUI may be invoked or launched, e.g., a Soft Front Pane1™ (SFP) application for the respective device, as provided by National Instruments Corporation. The GUI may connect to the measurement device that the application was using, tell a driver program for the measurement device to “snapshot” the initial configuration state, and allow the user to make changes to the measurement device's configuration.

Once the user is satisfied with the measurement device's configuration, e.g., the state of hardware, the user may use the GUI (e.g., SFP) to display the difference between the initial configuration (or configuration state), e.g., the configuration when the GUI was launched, before changes were made), and the current (modified) configuration. In the exemplary GUI of FIG. 6, three configuration parameters (referred to in the GUI as “properties”) have been changed, specifically, horizontal: minimum sample rate (from 50.000E+6 to 20.000E+6), triggering: trigger level (from 645.567E−3 to 216.396E−3), and triggering: trigger slope (from Negative to Positive), and thus the GUI presents the original value (from the initial configuration) and the new value for each parameter. Of course, these changes may be presented in other manners, e.g., an initial value and a change amount, the new value and the amount changed, etc.

The GUI's ability to show the differences may depend on functionality added to the driver software (e.g., functionality for saving/recalling configuration information). Thus, some aspects of the techniques described herein may be implemented in the driver software for the measurement device. The user may then decide whether to revert the configuration (state) back to the initial configuration, or keep the new configuration, e.g., possibly after the GUI is used to make changes, e.g., via the “Apply Changes” button shown. In other words, the GUI may allow the user to retain the current (modified) configuration for the measurement device, or revert to the initial configuration, e.g., via the “Revert Changes” button shown.

The above idea may be extended to a series of configuration changes as well. More specifically, the method may perform undo or redo functionality in response to user input based on the history of configuration changes, where at least one of the changes in configuration results from an undo or redo operation. Accordingly, in some embodiments, the GUI may display a series of configuration changes and/or a series of successive (initial and modified) configurations, e.g., either all at once, or one at a time, where the user may step backwards and forwards through the respective changes or configurations via invocation of “undo” and “redo” functions of the GUI.

Additionally, or alternatively, the user may simply select one of the configurations (or respective changes), either directly, or by stepping through a sequence individually, and the method may configure the measurement device accordingly. Thus, maintaining a history of configuration changes for the measurement device may be used to implement configuration change tracking, providing the user access to multiple modified configurations of the measurement device, any of which may be used to configure the measurement device.

Note that any data structures may be used to implement the techniques disclosed herein, e.g., one or more: queues, stacks, lists, or arrays, and so forth as desired.

In some embodiments, the method may include automatically generating a program executable to configure the measurement device in accordance with the selected configuration. In other words, once a configuration has been selected by the user, a program may be automatically generated or created that configures the measurement device accordingly. For example, the program may be executable by the host computer (or another computer) to modify the initial configuration of the measurement device in accordance with the selected modified configuration (or change in configuration), or replace the initial configuration of the measurement device with the selected modified configuration.

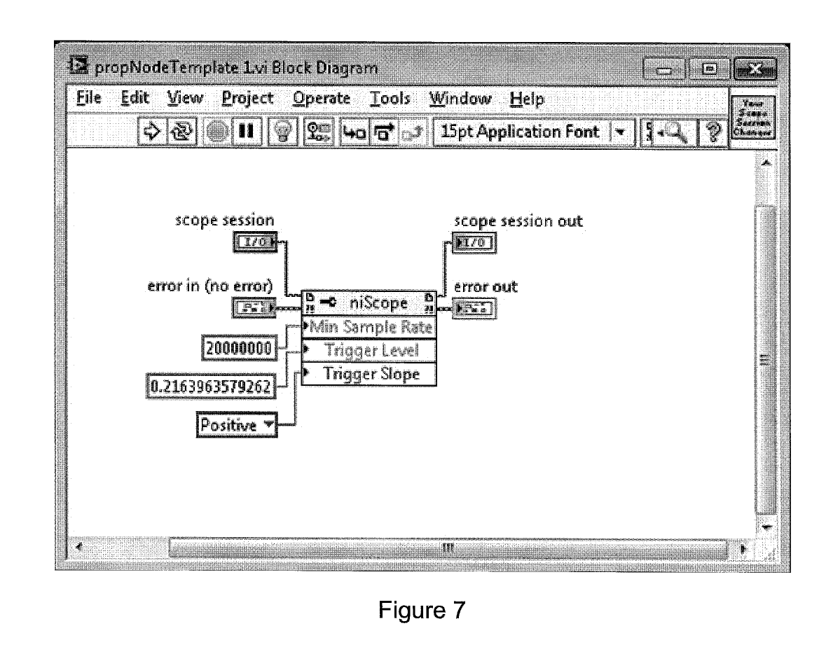

The automatically generated program may be any type of program desired, and in any programming language appropriate to the needs of the user. In one embodiment, the program may be or include a graphical program, and in some embodiments, may be or include a graphical data flow program, such as those created under the LabVIEW™ graphical programming system provided by National Instruments Corporation. Further information regarding graphical programming and graphical programming environments is provided in U.S. Pat. No. 4,914,568 titled “Graphical System for Modeling a Process and Associated Method”, and U.S. Pat. No. 5,481,741 titled “Method and Apparatus for Providing Attribute Nodes in a Graphical Data Flow Environment”, both of which were incorporated by reference above. An exemplary embodiment of such a program is shown in FIG. 7, described below.

### FIG. 7—Exemplary Generated Program

FIG. 7 illustrates an exemplary automatically generated program, according to one embodiment of the present techniques. More specifically, the program of FIG. 7 may be automatically generated or created, and may be executable to configure the measurement device according to a selected (or current) modified configuration, i.e., the new measurement device configuration parameter settings, as described above. For example, the program may be executable by the host computer (or another computer) to modify the initial configuration of the measurement device in accordance with the selected configuration changes (new parameter values), or in some embodiments, replace the initial configuration of the measurement device with a selected configuration.

The exemplary program of FIG. 7 is a graphical program, specifically, a graphical data flow program, created under that LabVIEW™ Graphical Program Development Environment provided by National Instruments Corporation. As shown, the program encodes provision of the new values for the measurement device's minimum sample rate (20.000E+6 or 20000000), trigger level (216.396E−3 or 0.216396), and trigger slope (Positive) to a Property Node labeled “niScope”, whereby the measurement device may be configured with these new values. For example, the graphical program of FIG. 7 may be automatically included in a user's application, and when the application executes, may set the configuration parameters of the measurement device accordingly.

### Exemplary Creation of a Graphical Program

The following describes various exemplary techniques for generating a graphical program. It should be noted, however, that the particular techniques described are exemplary only, and are not intended to limit the manner in which a program according to the present techniques is automatically generated.

The graphical program may be created or assembled by some embodiments of the present method by arranging a plurality of nodes or icons and then interconnecting the nodes to create the graphical program. In response to the method assembling the graphical program, data structures may be created and stored which represent the graphical program. The nodes may be interconnected in one or more of a data flow, control flow, or execution flow format. The graphical program may thus comprise a plurality of interconnected nodes or icons which visually indicates the functionality of the program. The graphical program may include a block diagram and may also include a user interface portion or front panel portion. In other embodiments, pre-defined code modules (possibly including associated underlying data structures) may be assembled by the method, e.g., above the level of individual nodes.

In one embodiment, the graphical program may be created by creating or specifying a prototype, followed by automatic or programmatic creation of the graphical program from the prototype. This functionality is described in U.S. patent application Ser. No. 09/587,682 titled “System and Method for Automatically Generating a Graphical Program to Perform an Image Processing Algorithm”, which is hereby incorporated by reference in its entirety as though fully and completely set forth herein. The graphical program may be created in other manners, either by the user or programmatically, as desired. The graphical program may implement a measurement function that is desired to be performed by the instrument.

In various embodiments, a block diagram for the graphical program may be created, e.g., by the present method, using any graphical programming development environment, such as LabVIEW™, Simulink, VEE, or another graphical programming development environment. It is noted that the graphical user interface and the block diagram may be created separately or together, in various orders, or in an interleaved manner. In one embodiment, the user interface elements in the graphical user interface or front panel may be specified or created, and terminals corresponding to the user interface elements may appear in the block diagram in response. For example, when the method places user interface elements in the graphical user interface or front panel, corresponding terminals may appear in the block diagram as nodes that may be connected to other nodes in the block diagram, e.g., to provide input to and/or display output from other nodes in the block diagram. In another embodiment, the user interface elements may be created in response to the block diagram. For example, the method may create the block diagram, wherein the block diagram includes terminal icons or nodes that indicate respective user interface elements. The graphical user interface or front panel may then be automatically (or manually) created based on the terminal icons or nodes in the block diagram. As another example, the graphical user interface elements may be comprised in the block diagram itself.

Of course, in other embodiments, the generated program may be or include a text-based program, e.g., in a textual programming language, such as C, C++, JAVA, etc., and/or any combination of graphical and textual programming languages, as desired.

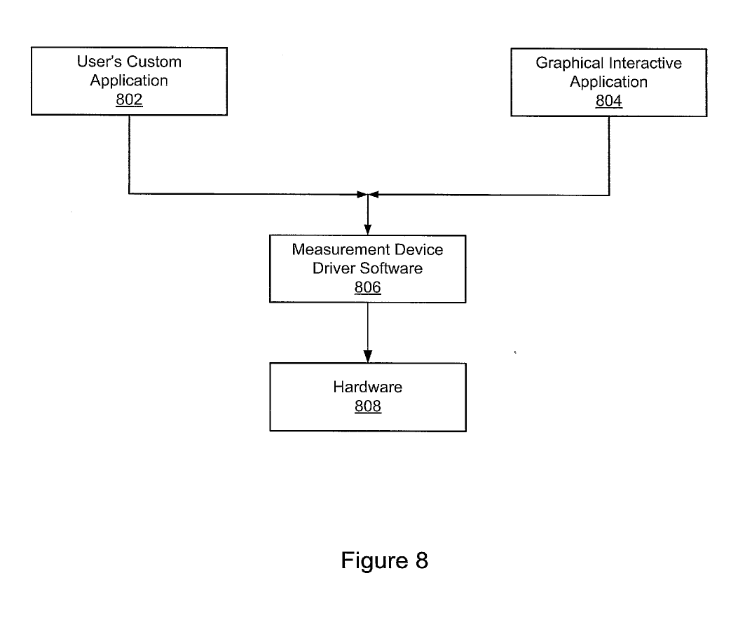

### FIG. 8—Exemplary Architecture

FIG. 8 illustrates a high level system architecture, according to one exemplary embodiment. As indicated, a user's custom application 802 and a graphical interactive application 804, e.g., a software tool or component that implements an embodiment of the above-described GUI, may operate in conjunction with or through measurement device driver software 806, to configure and otherwise interact with hardware 808, i.e., the measurement device. Note that in various embodiments, the custom application, the graphical interactive application (or tool/GUI), and/or the measurement device driver software, may be implemented or executed on a host computer or controller or on the measurement device itself, e.g., the hardware (808).

Thus, embodiments of the techniques described herein may facilitate configuration change tracking and associated functionality for a measurement device.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A non-transitory computer accessible memory medium that stores program instructions executable by a processor to perform:
storing an initial configuration of a measurement device on a storage medium; and
repeating one or more times:
storing, in response to a change in the configuration of the measurement device resulting in a modified configuration, information indicating the modified configuration on the storage medium;
wherein the stored initial configuration and the stored information indicating each modified configuration comprise a history of configuration changes for the measurement device, and wherein the history of configuration changes is useable to perform one or more of:
generating a report regarding the measurement device;
displaying the history of configuration changes for the measurement device; or reverting the measurement device to a previous configuration.

2. The non-transitory computer accessible memory medium of claim 1, wherein the stored information indicating each modified configuration comprises:
new values for one or more configuration parameters of the measurement device resulting from each change in configuration, wherein the new values for the one or more configuration parameters override previous values of the one or more configuration parameters.

3. The non-transitory computer accessible memory medium of claim 1, wherein the stored information indicating each modified configuration comprises:
values of configuration parameters that have not been changed from the initial configuration; and
new values for configuration parameters of the measurement device resulting from the changes in configuration, wherein later new values override previous new values.

4. The non-transitory computer accessible memory medium of claim 1, wherein the stored information indicating changes in the configuration comprises:
respective differences between the modified configurations of the measurement device resulting from the changes in configuration and the initial configuration.

5. The non-transitory computer accessible memory medium of claim 1, wherein the program instructions are further executable to perform:
determining respective differences between the initial configuration and each modified configuration based on the history of configuration changes for the measurement device.

6. The non-transitory computer accessible memory medium of claim 1, wherein the initial configuration and the modified configurations comprise a plurality of configurations, and wherein the program instructions are further executable to perform:
receiving user input indicating a first configuration of the plurality of configurations; and
selecting the first configuration in response to said receiving user input, wherein the first configuration is useable to configure the measurement device.

7. The non-transitory computer accessible memory medium of claim 6, wherein the program instructions are further executable to perform:
automatically generating a program executable to configure the measurement device in accordance with the selected configuration.

8. The non-transitory computer accessible memory medium of claim 7, wherein to configure the measurement device in accordance with the selected configuration, the program is executable to:
modify the initial configuration of the measurement device in accordance with the selected configuration; or
replace the initial configuration of the measurement device with the selected configuration.

9. The non-transitory computer accessible memory medium of claim 7, wherein the program comprises a graphical program.

10. The non-transitory computer accessible memory medium of claim 9, wherein the graphical program comprises a graphical data flow program.

11. The non-transitory computer accessible memory medium of claim 1, wherein the program instructions are further executable to perform:
undo or redo functionality in response to user input based on the history of configuration changes;
wherein at least one of the changes in configuration results from an undo or redo operation.

12. The non-transitory computer accessible memory medium of claim 1, wherein the measurement device comprises one or more of:
a standalone instrument;
a module in a chassis;
a chassis with a plurality of modules; or
a device comprising:
a software component, executable on a host computer; and
a hardware component, coupled to the host computer.

13. A computer-implemented method for configuring a measurement device, the method comprising:
a computing device performing:
storing an initial configuration of a measurement device on a storage medium; and
repeating one or more times:
storing, in response to a change in the configuration of the measurement device, information indicating the change in the configuration on the storage medium, wherein the change in the configuration results in a modified configuration;
wherein the stored initial configuration and the stored information indicating changes in the configuration comprise a history of configuration changes for the measurement device, and wherein the history of configuration changes is useable to perform one or more of:
generating a report regarding the measurement device;
displaying a history of changes in the configuration of the measurement device; or
reverting the measurement device to a previous configuration.

14. The computer-implemented method of claim 13, wherein the stored information indicating each modified configuration comprises:
new values for one or more configuration parameters of the measurement device resulting from each change in configuration, wherein the new values for the one or more configuration parameters override previous values of the one or more configuration parameters.

15. The computer-implemented method of claim 13, wherein the stored information indicating each modified configuration comprises:
values of configuration parameters that have not been changed from the initial configuration; and
new values for configuration parameters of the measurement device resulting from the changes in configuration, wherein later new values override previous new values.

16. The computer-implemented method of claim 13, wherein the stored information indicating changes in the configuration comprises:
respective differences between the modified configurations of the measurement device resulting from the changes in configuration and the initial configuration.

17. The computer-implemented method of claim 16, further comprising:
determining respective differences between the initial configuration and each modified configuration based on the history of configuration changes for the measurement device.

18. The computer-implemented method of claim 13, wherein the initial configuration and the modified configurations comprise a plurality of configurations, the method further comprising:
receiving user input indicating a first configuration of the plurality of configurations; and
selecting the first configuration in response to said receiving user input, wherein the first configuration is useable to configure the measurement device.

19. The computer-implemented method of claim 18, further comprising:
automatically generating a program executable to configure the measurement device in accordance with the selected configuration.

20. The computer-implemented method of claim 19, wherein to configure the measurement device in accordance with the selected configuration, the program is executable to perform:
modifying the initial configuration of the measurement device in accordance with the selected configuration; or
replacing the initial configuration of the measurement device with the selected configuration.

21. The computer-implemented method of claim 18, wherein the program comprises a graphical program.

22. The computer-implemented method of claim 21, wherein the graphical program comprises a graphical data flow program.

23. The computer-implemented method of claim 13, further comprising:
performing an undo or redo operation in response to user input based on the history of configuration changes;
wherein at least one of the changes in configuration results from the undo or redo operation.

24. The computer-implemented method of claim 11, wherein the measurement device comprises one or more of:
a standalone instrument;
a module in a chassis;
a chassis with a plurality of modules; or
a device comprising:
a software component, executable on a host computer; and
a hardware component, coupled to the host computer.

25. A system comprising:
a processor; and
a memory medium, coupled to the processor, wherein the memory medium stores program instructions executable by the processor to:
store an initial configuration of a measurement device on a storage medium; and
perform a plurality of times:
store, in response to a change in the configuration of the measurement device resulting in a modified configuration, information indicating the modified configuration on the storage medium;
wherein the stored initial configuration and the stored information indicating each modified configuration comprise a history of configuration changes for the measurement device, and wherein the history of configuration changes is useable to:
generate a report regarding the measurement device;
display the history of configuration changes for the measurement device; or
reverting the measurement device to a previous configuration.
